(19) United States
(12) Patent Application Publication
(10) Pub. No.: US 2002/0032743 A1
(43) Pub. Date: Mar. 14, 2002

(54) Method for providing e-mail service

(75) Inventors: Jae Seock Lee, Seoul (KR); Kyo Weon Lee, Pusan-shi (KR); Hee Bae Kim, Kyongsangbuk-do (KR); Bong Suk Park, Kyongsangnam-do (KR); Sang Jun Lee, Seoul (KR); Dae Ki Kim, Seoul (KR); Sang Cheol Nam, Seoul (KR); Soon Cheol Hong, Seoul (KR); Hyeong Sook Seol, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 09/947,386

(22) Filed: Sep. 7, 2001

(30) Foreign Application Priority Data
Sep. 9, 2000 (KR) 2000-53728

(51) Int. Cl. G06F 15/16

(52) U.S. Cl. 709/206

(57) ABSTRACT

A method of providing a web-based e-mail service is disclosed, in which a user can conveniently check and manage e-mail messages. The method of providing a web-based e-mail service on a web site to a user having an e-mail account, the method includes the steps of: displaying basic information of each of incoming/outgoing e-mail messages in a predetermined frame of the web site when the user accesses the web site to check the e-mail messages; selecting a desired e-mail message by the user; displaying detailed information of the desired e-mail message in an incoming message displaying frame if the selected message is an incoming message; and displaying detailed information of the desired e-mail message in an outgoing message displaying frame if the selected message is an outgoing message.

### BACKGROUND OF THE INVENTION

1. Field of the Invention

The present invention relates to an e-mail service, and more particularly, to a method of providing a web-based e-mail service in which a user can easily check e-mail messages sent to and received from a desired user among a number of users.

2. Background of the Related Art

Recently, with the increase of Internet users based on World Wide Web (WWW) and Transmission Control Protocol/Internet Protocol (TCP/IP), e-mail service is increasingly used as a medium for information transmission through Internet.

Particularly, a web-based e-mail transmission is being widely used, in which a user directly accesses a web site that provides an e-mail service, to send/receive e-mail message to/from a desired user.

FIG. 1 is a schematic view of a related art e-mail service system established to send/receive a web mail message.

Referring to FIG. 1, the related art e-mail service system includes an Internet service provider (ISP) network 20 connected with a transmitting terminal unit 10, an ISP network 40 connected with the ISP network 20 through Internet and at the same time connected with a receiving terminal unit 30, and mail servers 21 and 41 providing e-mail services to each user in a state where they are respectively connected with a corresponding ISP network.

Real web mail sending and receiving procedures will be described with reference to FIG. 2 illustrating a web mail service procedure in general portal sites.

When a user having an e-mail account accesses a web site through its terminal unit to transmit or check e-mail messages, the web site displays an e-mail service web page 110 as shown in FIG. 3a.

At this time, basic items such as “inbox (read message)” 110a, “compose” 110b are displayed on the e-mail service web page 110, and additional service items such as “sent message confirmation” 100c, “address book” 100d, “options” 110e, “subscribers data” 110f, and various advertisements are displayed thereon.

Therefore, the user selects one of the items to use a corresponding service.

The respective items will be described in brief.

The item “inbox” 110a is to read all the e-mail messages sent to an e-mail account of the user. If the user selects this item “inbox”, the web page 120 including the whole e-mail messages sent to a corresponding e-mail account is displayed as shown in FIG. 3b. If the user selects one 120a of the displayed e-mail messages, a web page 130 including a corresponding e-mail message is displayed as shown in FIG. 3c.

The item “compose” 110b is to allow the user to compose a message and to send the composed message to an e-mail account of a recipient. If the user selects this item “compose” 110b, a web page 140 for composing a message is displayed as shown in FIG. 3d.

Meanwhile, if the user desires to reply to any e-mail message while the user checks the item “compose” the user should select a “reply” button 130a activated on a screen of FIG. 3c in a state where a user interface corresponding to the e-mail message is displayed.

In this case, as shown in FIG. 3e, a compose message web page 150 is displayed and an e-mail address of a recipient is automatically input to a recipient line 150a, and an incoming e-mail message is displayed in a text frame 150b.

Afterwards, the user composes a message in the frame 150b of a corresponding reply message and selects a send message button 150c. Then, a corresponding e-mail message is sent to the e-mail address of the recipient.

However, the aforementioned method of providing a web-based e-mail service has several problems. In case where the user desires to check an e-mail message, a new web page is displayed and at the same time the e-mail message is displayed on the displayed web page. In this case, a problem arises in that time loss is caused as the new web pages 120 and 130 are displayed. In other words, the buffering time is essentially required to display the web pages 120 and 130.

Furthermore, if the user desires to reply to the displayed e-mail message after checking it, new web pages 140 and 150 for composing a message should be displayed. This could lead to time loss and inconvenience.

To solve such problems, there is provided a separate e-mail service program (e-mail client program) such as outlook express program provided by Microsoft Company Ltd., which is installed on a personal PC and accessed to a mail server to simply send or receive e-mail message.

In the outlook express program, a list of incoming e-mail messages and contents of any one e-mail message of them are simultaneously displayed within one window so that the user can more simply check e-mail message. That is to say, if the user selects any one e-mail message from the list of incoming e-mail messages displayed on an upper frame 160a of a program window 160, as shown in FIG. 3f, detailed contents of the selected e-mail message are displayed on a lower frame 160b.

This e-mail service program has an advantage in that it can be used even without accessing a web site.

However, in this e-mail service program, the user should select its desired e-mail message after checking each brief description (generally, “subject”) of incoming e-mail messages. Also, if the user desires to reply to the selected e-mail message, a new window for composing a message should be activated.

Particularly, although an effective area within a frame where the user composes a reply message to the selected e-mail message has a limited size in a program window, it contains both the outgoing e-mail message as well as the reply message. A recipient of the reply message should manipulate a scroll bar of the frame to check a portion not appeared, so that the recipient can check the reply message. In this case, the user suffers difficulty in checking incoming e-mail messages. Also, a problem arises in that it is difficult to exactly list up the respective outgoing e-mail messages and incoming e-mail messages.

The aforementioned related art e-mail service also has a problem in that the user should check a list of all the incoming e-mail messages to check a new e-mail message or an e-mail message not read. That is, the number of e-mail messages not read is displayed and the e-mail messages not read are separately marked on the list of the whole incoming e-mail messages, so that the user can identify which e-mail messages have not been read. In this case, the user suffers inconvenience to check whole the incoming e-mail messages. Moreover, since all the incoming and outgoing e-mail messages are classified according to dates, it is difficult to check the e-mail messages according to specific conditions.

### SUMMARY OF THE INVENTION

Accordingly, the present invention is directed to a method of providing a web-based e-mail service that substantially obviates one or more problems due to limitations and disadvantages of the related art.

An object of the present invention is to provide a method of providing a web-based e-mail service in which a user can conveniently check messages of incoming e-mail messages.

Another object of the present invention is to provide a method of providing a web-based e-mail service in which a user can easily check the status of incoming e-mail messages to improve applicability of e-mail to business.

Other object of the present invention is to provide a method of providing a web-based e-mail service in which a user can conveniently manage e-mail messages.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of providing a web-based e-mail service on a web site to a user having an e-mail account, the method includes the steps of: displaying basic information of each of incoming/outgoing e-mail messages in a predetermined frame of the web site when the user accesses the web site to check the e-mail messages; selecting a desired e-mail message by the user; displaying detailed information of the desired e-mail message in an incoming message displaying frame if the selected message is an incoming message; and displaying detailed information of the desired e-mail message in an outgoing message displaying frame if the selected message is an outgoing message.

The basic information of each of the incoming/outgoing e-mail messages includes at least one of recipient/sender data, a brief description of the incoming/outgoing e-mail messages, and e-mail message received/sent dates.

Preferably, the text shown in the incoming message displaying frame cannot be altered, and the outgoing message displaying frame has a space in which the user can type in a reply message to the incoming e-mail message.

The user inputs at least one of the sent date, a mail account or name of a recipient, an outgoing e-mail message, and a brief description of the e-mail message in the outgoing message displaying frame, so as to reply to the incoming e-mail message and to forward the incoming e-mail message to another user.

In another aspect, a method of providing a web-based e-mail service on a web site to a user having an e-mail account, the method includes the steps of: displaying the text of an e-mail service, which is selected by the user among various e-mail services provided from an e-mail service system, on a screen in a state where the user accesses the web site to check e-mail messages; requesting search conditions to implement search according to conditions of the selected e-mail service; searching a corresponding DB based on information of the search conditions input by the user to display the information; and displaying detailed information of an e-mail message requested by the user among displayed e-mail messages.

The e-mail services provided from the e-mail service system include an e-mail service for checking incoming/outgoing e-mail messages and an e-mail service for sending an e-mail message, and the search conditions for the selected e-mail service include at least one of an item for a required e-mail message type of the incoming/outgoing e-mail messages, an item for a desired search period from the incoming/outgoing e-mail messages, an item for respective senders, and an item for displaying read e-mail messages, e-mail messages not read, or all the incoming/outgoing e-mail messages.

Preferably, each of the incoming/outgoing e-mail messages has a message sequence number for checking its status.

More preferably, the message sequence numbers of the incoming/outgoing e-mail messages are sequentially assigned when a sender successively sends e-mail messages on even date. Also, the message sequence numbers of the incoming/outgoing e-mail messages are sequentially assigned depending on the time when the e-mail messages are sent, so as to group e-mail messages sent from a sender, related e-mail messages sent from different senders, and reply e-mail messages.

The method further includes the step of searching a DB corresponding to the web site accessed by the user to display basic information of e-mail messages not read by the user on a corresponding screen. The basic information of the e-mail messages not read includes sender data, a brief description of the e-mail messages, and the sent date.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a general e-mail service system;

FIG. 2 is a flow chart illustrating a general e-mail service procedure;

FIGS. 3a to 3f show web pages displayed in the general e-mail service procedure;

FIG. 4 is a flow chart illustrating a method of providing a web-based e-mail service according to the first embodiment of the present invention;

FIGS. 5a to 5e show web pages displayed in the web-based e-mail service according to the first embodiment of the present invention;

FIG. 6 is a flow chart illustrating a method of providing a web-based e-mail service according to the second embodiment of the present invention; and

FIGS. 7a to 7c show web pages displayed in the web-based e-mail service according to the second embodiment of the present invention.

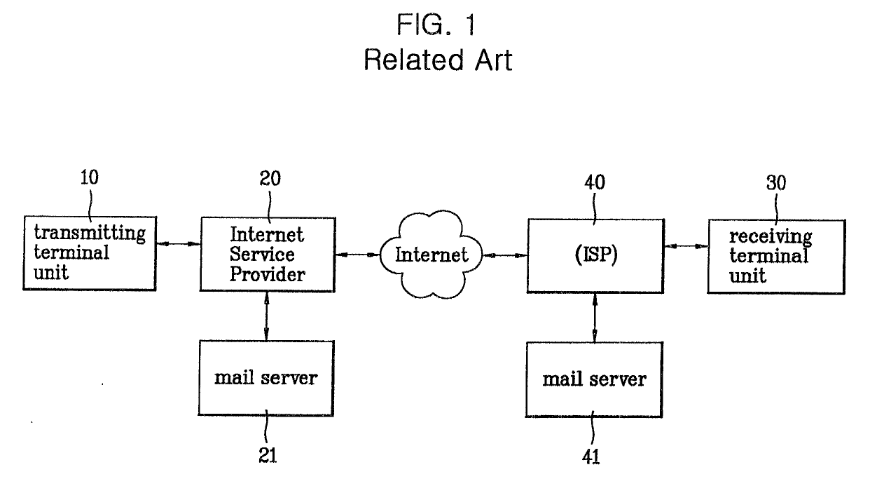

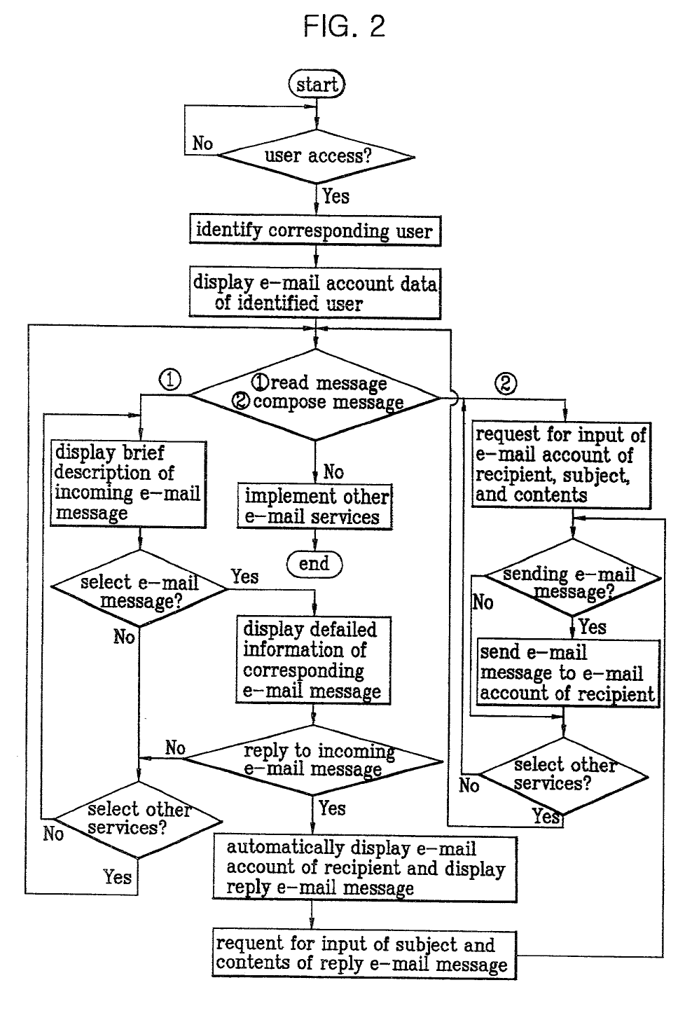

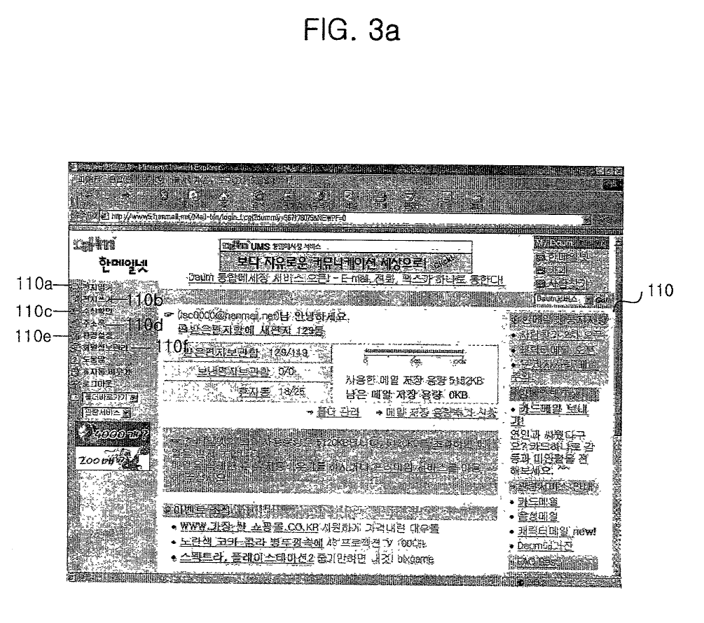

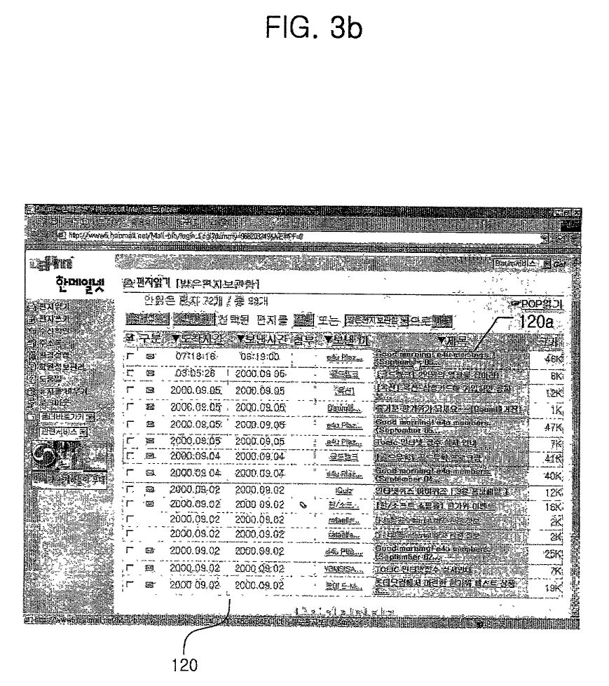

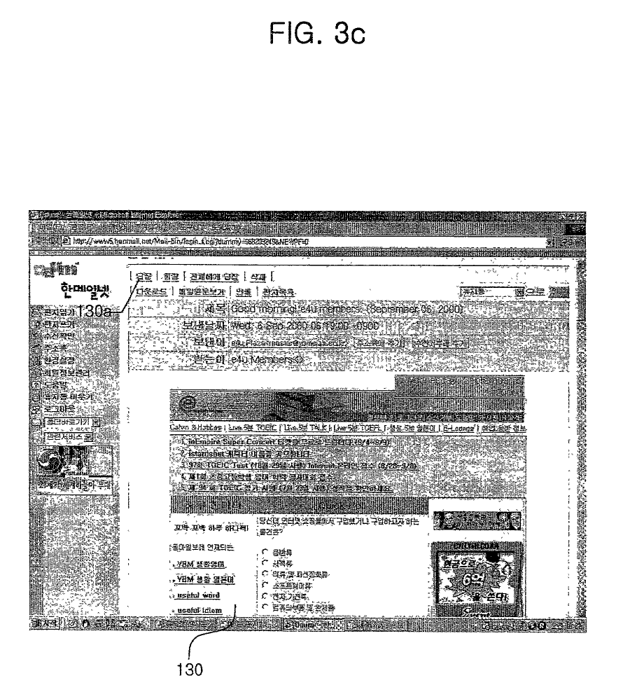

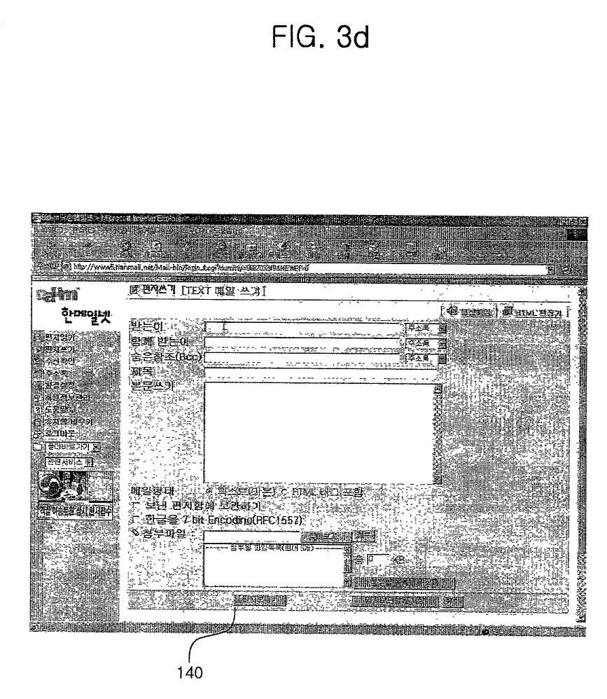

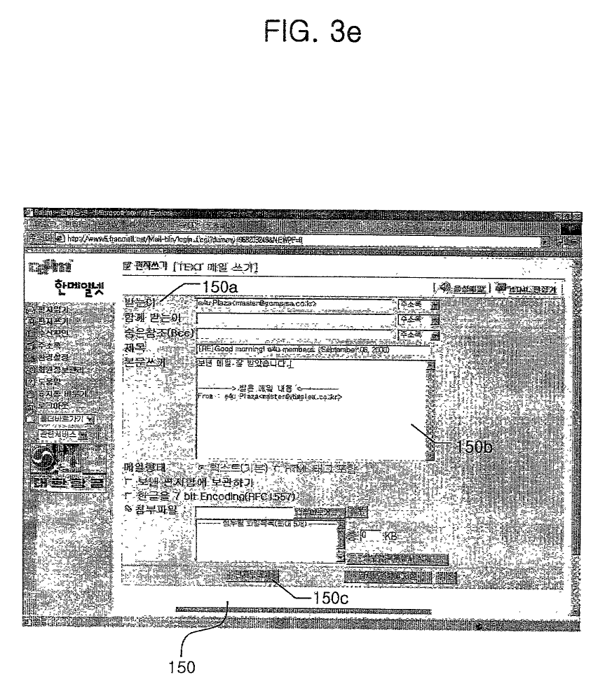

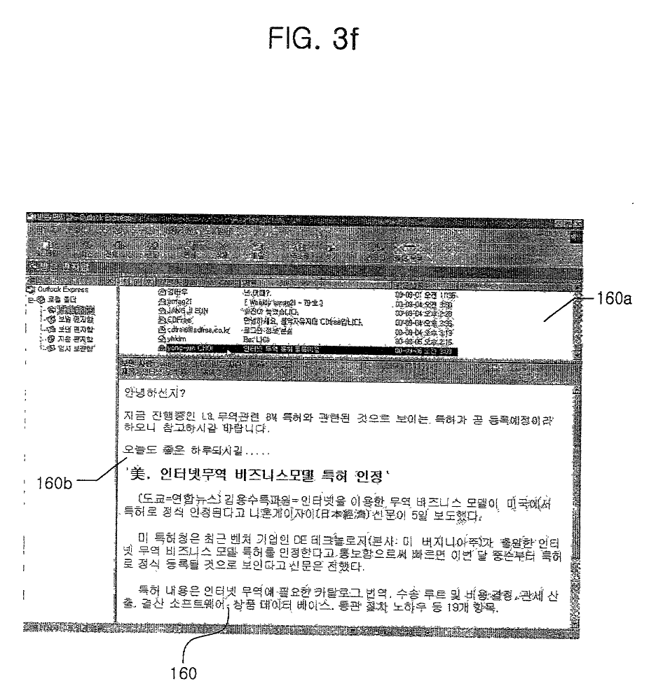

### DETAILED DESCRIPTION OF THE PREFERRED EMBODIMENTS

Reference will now be made in detail to the preferred embodiments of the present invention, examples of which are illustrated in the accompanying drawings.

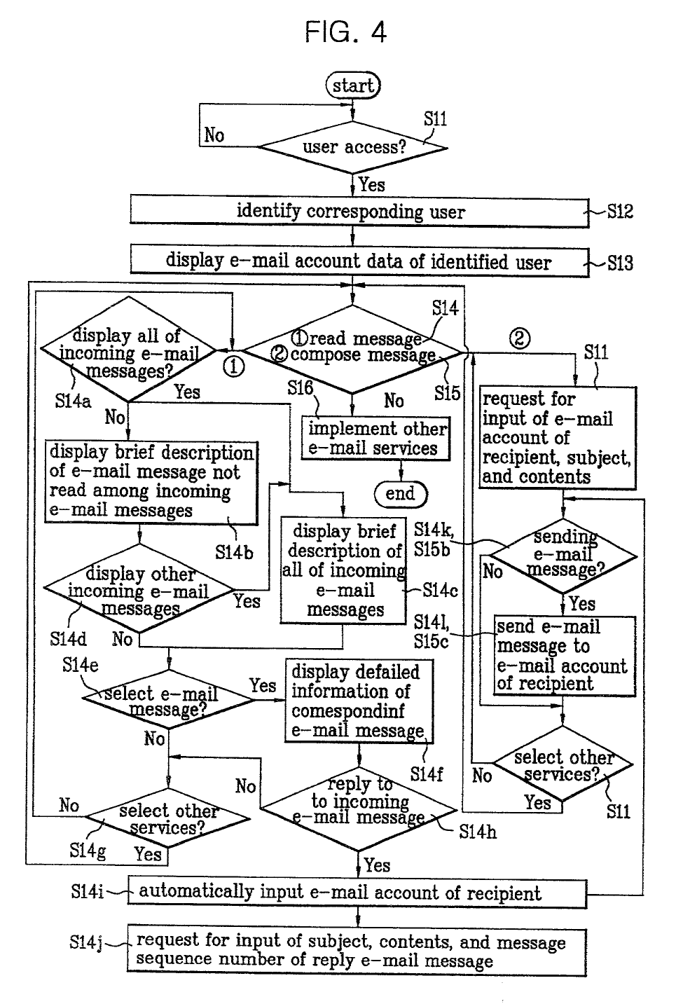

FIG. 4 is a flow chart illustrating a method of providing a web-based e-mail service according to the first embodiment of the present invention.

In a method for operating a web-based e-mail service system according to the first embodiment of the present invention, if a user having an e-mail account accesses a web site to check e-mail messages, basic information of at least one of incoming/outgoing e-mail messages stored in an e-mail account of the user is displayed in a predetermined frame on a screen. If the user selects an e-mail message from a list of the incoming e-mail messages, the selected e-mail message is displayed in either an incoming message displaying frame or an outgoing message displaying frame.

In more detail, if the user having an e-mail account accesses a web site to check e-mail messages, a server of the web site identifies the user (S11 and S12). This is implemented through a general log in procedure. The server obtains user data through the log in procedure and supplies status data of the e-mail account and a corresponding mail service to the user in conjunction with a data base (DB) that stores the user data (S13).

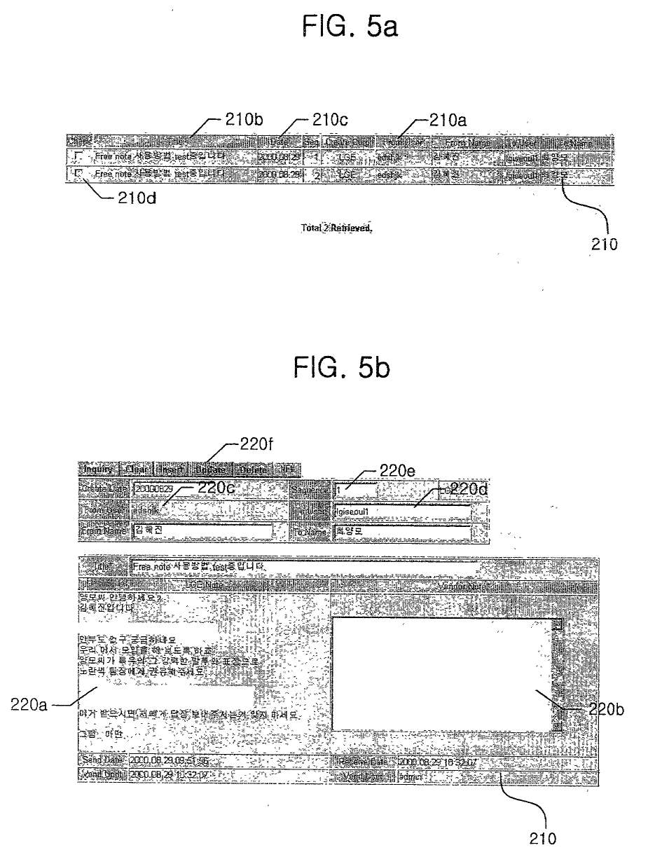

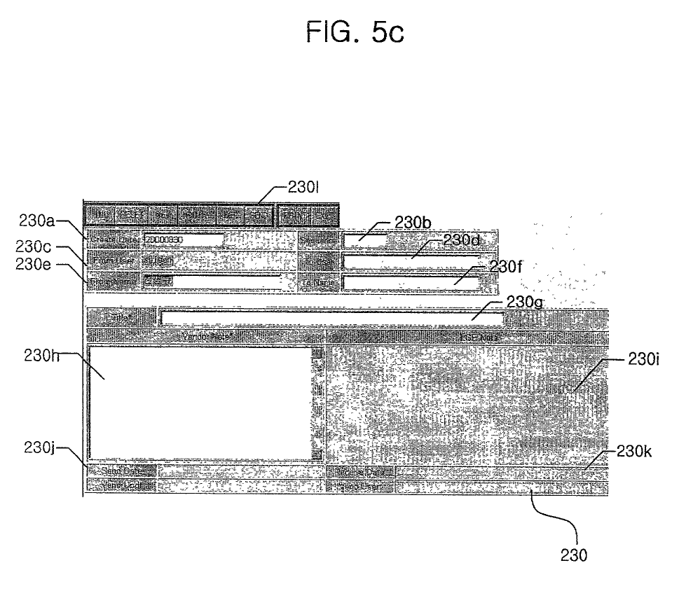

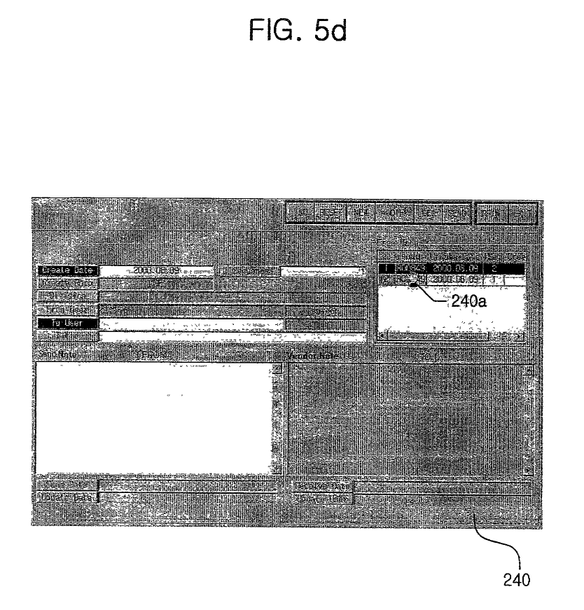

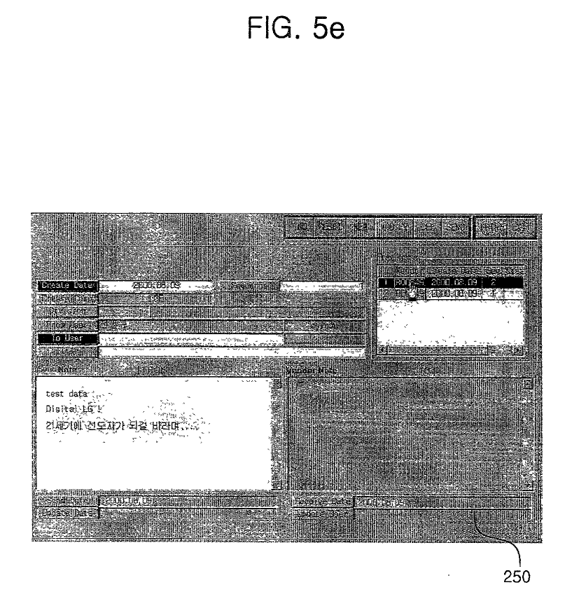

Afterwards, if the user desires to check an incoming e-mail message (S14), the user selects a check mail button (S14a). The server displays a web page 210 on a screen, which contains only e-mail messages not read among e-mail messages received in the e-mail account of the user, as shown in FIG. 5a (S14b) Alternatively, the server displays a web page which contains all the incoming/outgoing e-mail messages (S14c) Also, after the step S14b, other incoming e-mail messages can additionally be checked (S14d).

In case of the web page 210 which contains only e-mail messages not read, the basic information of the e-mail messages not read includes sender data 210a, a brief description (generally, “subject”) of the e-mail messages, and the sent date 210c.

If the user desires to check any one of the incoming e-mail messages, the user has only to select a check window 210d of the desired e-mail message (S14e). In this case, a web page 220 which contains detailed information of the selected e-mail message in a corresponding frame is displayed on the screen as shown in FIG. 5b (S14f). Furthermore, a general e-mail check can be implemented even before the step S14e or after the step S14f.

In the step S14f, the web page 220 includes an incoming message displaying frame 220a and an outgoing message displaying frame 220b. Detailed information of the incoming e-mail message is output within the effective area of the incoming message displaying frame. The effective area means an area where various messages are composed or displayed.

The text shown in the incoming message displaying frame 220a cannot be altered, and the outgoing message displaying frame 220b has a space in which the user can type in a reply message to the incoming e-mail message.

Also, a sender mail account and a recipient mail account are automatically input to corresponding input windows 220c and 220d of the web page 220. An attached file list and a message sequence number 220e can preferably be added to the web page 220. The message sequence number 220e is to check the status of a corresponding e-mail message, and is sequentially assigned to e-mail messages when a sender successively sends the e-mail messages on even date. The message sequence number 220e may be used to group e-mail messages sent from one sender, related e-mail messages sent from different senders, reply e-mail messages sent, and so on.

If the user desires to reply to the incoming e-mail message as the case may be (S14h), the user inputs a message on the incoming message displaying frame 220b (S14j) and selects a reply button (update button in the drawing) (S14k).

The server identifies a recipient of the reply e-mail message, i.e., the input window 220d of the sender e-mail account and at the same time replies to the e-mail account of the recipient (S14l)

Therefore, it is not necessary to activate a new display window for reply to the incoming e-mail message. The buffering time for a new display window is not required, either.

Furthermore, when considering that the incoming e-mail message and its reply e-mail message are displayed within the effective area of a corresponding frame in a state where they are separated from each other, the recipient can check the reply e-mail message and its outgoing e-mail message on one user interface and can easily identify the outgoing e-mail message corresponding to the reply e-mail message because the outgoing e-mail message is displayed to correspond to the reply e-mail message. Thus, the user can easily compare the outgoing e-mail message with its reply e-mail message. This improves business efficiency of a user who uses the e-mail service for business.

Meanwhile, if the user desires to compose a new mail and send it (S15), a web page 230 shown in FIG. 5c is displayed.

In other words, a create date 230a, a message sequence number 230b, an e-mail ID 230c of a sender, a e-mail account 230d of a recipient, a name 230e of a sender, a name 230f of a recipient, a subject 230g, an outgoing message input frame 230h, an incoming message output frame 230i, a sent date 230i, and a received date 230k are displayed on the screen. Of them, the sent date 230j, the message sequence number 230b, the e-mail account 230d of the recipient, the name 230e of the sender, the name of the recipient 230f, the outgoing message input frame 230h are activated to input corresponding contents.

Therefore, if the user desires to compose a new mail and send it, corresponding contents are input on the respective activated frames (S15a). Then, the user selects a send button 230l, and the server identifies the e-mail account of the recipient and at the same time sends a message composed by the sender to the e-mail account of the recipient (S15c). Also, a general e-mail management can be implemented even after the step S15c.

Meanwhile, unlike the aforementioned e-mail services such as read message services (S14a˜S14l) and compose message services (S15a˜S15d), in the present invention, a separate e-mail management service including e-mail message delete service and e-mail message movement service may be provided (S16).

FIGS. 5d and 5e show modified examples according to the first embodiment of the present invention.

In other words, when the user logs in the e-mail service, the web page 240 for basic e-mail service is displayed and at the same time a list of the incoming e-mail messages is displayed in a predetermined frame 240a (corresponding to Free Note in FIG. 5d).

At this time, if the user selects one incoming e-mail message from the list of the incoming e-mail messages to check the incoming e-mail messages, detailed contents of the selected one are displayed on a corresponding frame as shown in the web page 250 of FIG. 5e. In this case, a method for replying to the incoming e-mail message and a method for composing a new e-mail message will be implemented in the same manner as the first embodiment. Therefore, their detailed description will be omitted.

In the second embodiment of the present invention, a method of providing a web-based e-mail service is additionally provided, in which incoming/outgoing e-mail messages can be searched according to conditions.

In other words, in the second embodiment of the present invention, a service for checking e-mail messages provided by the e-mail service system and a service for sending e-mail messages can be searched according to conditions.

At this time, the search conditions for the selected e-mail service include at least one of an item for a required e-mail message type of the incoming/outgoing e-mail messages, an item for a desired search period from the incoming/outgoing e-mail messages, an item for respective senders, and an item for displaying read e-mail messages, e-mail messages not read, or all the incoming/outgoing e-mail messages.

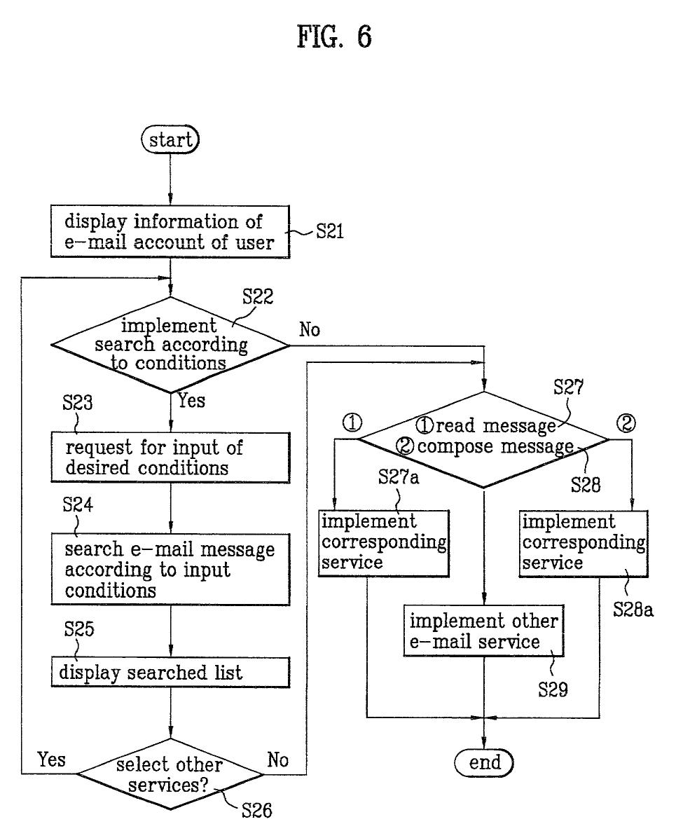

The method of providing a web-based e-mail service according to the second embodiment of the present invention will now be described with reference to FIG. 6.

FIG. 6 is a flow chart based on a method for checking incoming e-mail messages through search according to the received date.

In a state where the user having an e-mail account accesses a web site to check e-mail messages, once the user selects any one of the services provided from the mail service system, the server displays a web page of the selected service (S21).

At this time, the user is essentially in log in state to use a corresponding service. The log in procedure is identical to that of the first embodiment and thus its detailed description will be omitted.

The services provided from the e-mail service system include a service for checking incoming/outgoing e-mail messages and a service for sending e-mail messages.

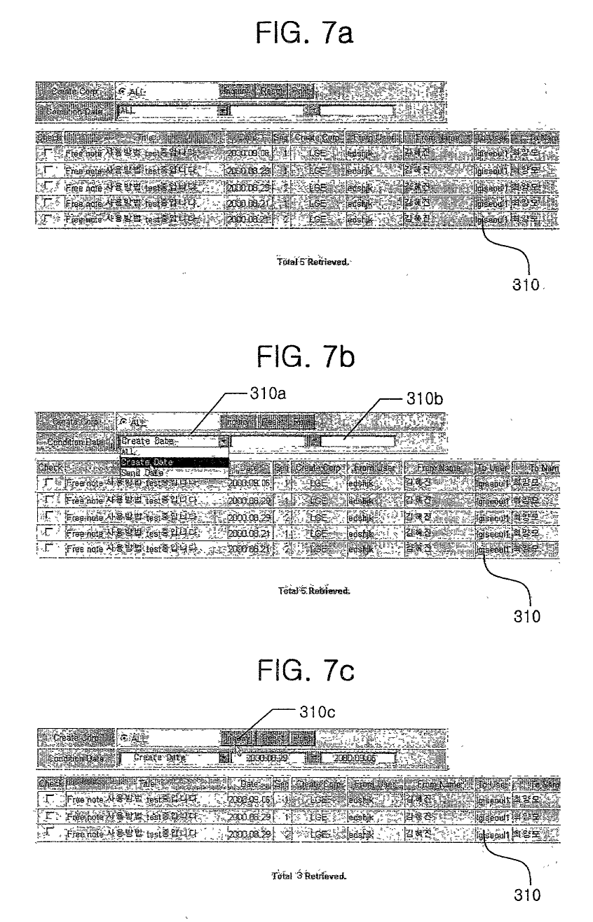

FIG. 7a shows a basic web page 310 including a list of all the incoming e-mail messages.

In this case, the user selects an item 310a (corresponding to Create Date) using a down menu as shown in FIG. 7b (S22).

The user inputs a desired time period in a date input frame 310b (empty frame of Condition Date in FIG. 7a) and then selects a selection button (inquiry button in FIG. 7c) (S22). In this case, the server identifies a search list input by the user and activates a search engine referring to the input list so as to check e-mail messages received in the e-mail account of the user for the desired time period (S24).

Once the search engine searches the incoming/outgoing e-mail messages corresponding to the e-mail account of the user for the corresponding time period based on the search conditions input by the user, the searched list is displayed on the screen as shown in FIG. 7c (S25).

Therefore, the user can check desired information only.

As described above, in addition to the search conditions according to the time period, the search conditions include a list of e-mail message according to e-mail message types, a list of e-mail messages according to senders, and a list of e-mail messages according to read e-mail messages, e-mail messages not read, or all the incoming/outgoing e-mail messages.

The list of e-mail messages according to the e-mail message types can be searched by selecting a keyword corresponding to a subject of a desired e-mail message. The list of e-mail messages according to senders can be searched by selecting a sender of a desired e-mail message. Finally, the list of read e-mail messages, e-mail messages not read, or all the incoming/outgoing e-mail messages can be searched by selecting any one of the list of e-mail messages. Since these search procedures are identical to the search procedure according to the time period, their detailed description will be omitted.

To check detailed contents of an e-mail message which the user desires to do, the user can select a corresponding e-mail message list (S27 and S27a) and can also implement works related to composing and sending a new e-mail message (S28 and S28a).

Meanwhile, in the second embodiment of the present invention, when the user accesses a web site, the server which manages the web site searches a corresponding DB and displays a web page containing basic information of e-mail messages not read by the user, on a corresponding screen.

That is, brief contents of e-mail messages not read are displayed as soon as the user accesses its e-mail account, so that the user can easily check the e-mail messages not read.

At this time, the displayed brief contents of the e-mail message not read include a sender, a brief description of the e-mail message, and a sent date. Accordingly, the user can more easily check information of the e-mail message not read.

The method for managing the e-mail service system according to the present invention is not limited to the aforementioned description. All of services that can be provided by a general e-mail service system can be implemented by the method of the present invention.

The method for managing the e-mail service system according to the present invention is implemented similarly to the management procedure of the general e-mail service system. Therefore, its detailed description will be omitted.

As aforementioned, the method of providing a web-based e-mail service according to the present invention has the following advantages.

A frame for reading an e-mail message and a frame for replying to the read e-mail message are simultaneously displayed on the screen in a state where they are separated from each other. Therefore, the user can simply check e-mail messages, especially reply e-mail messages. In this case, a new screen for composing a reply e-mail message is not needed to be displayed. Accordingly, time loss can be reduced.

Furthermore, when the user logs in the e-mail service system, the user can only check e-mail messages not read in accordance with an option set by the user, thereby removing any inconvenience in searching e-mail messages not read among all the e-mail messages.

The user can selectively check incoming e-mail messages in accordance with its intention. Particularly, the user can check only a desired e-mail message when he/she receives a number of incoming e-mail messages.

Consequently, the user can efficiently manage its e-mail account.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of providing a web-based e-mail service on a web site to a user having an e-mail account, the method comprising the steps of:
displaying basic information of each of incoming/outgoing e-mail messages in a predetermined frame of the web site when the user accesses the web site to check the e-mail messages;
selecting a desired e-mail message by the user;
displaying detailed information of the desired e-mail message in an incoming message displaying frame if the selected message is an incoming message; and
displaying detailed information of the desired e-mail message in an outgoing message displaying frame if the selected message is an outgoing message.

2. The method of claim 1, wherein the basic information of each of the incoming/outgoing e-mail messages includes at least one of recipient/sender data, a brief description of the incoming/outgoing e-mail messages, and e-mail message received/sent dates.

3. The method of claim 1, wherein the text shown in the incoming message displaying frame cannot be altered, and the outgoing message displaying frame has a space in which the user can type in a reply message to the incoming e-mail message.

4. The method of claim 1, wherein the user inputs at least one of the sent date, a mail account or name of a recipient, an outgoing e-mail message, and a brief description of the e-mail message in the outgoing message displaying frame, so as to reply to the incoming e-mail message and to forward the incoming e-mail message to another user.

5. The method of claim 1, further comprising the step of searching a DB corresponding to the web site accessed by the user to display basic information on e-mail messages not read by the user on a corresponding screen.

6. The method of claim 5, wherein the basic information of the e-mail mails not read includes sender data, a brief description of the e-mail messages, and the sent date.

7. A method of providing a web-based e-mail service on a web site to a user having an e-mail account, the method comprising the steps of:
displaying the text of an e-mail service, which is selected by the user among various e-mail services provided from an e-mail service system, on a screen in a state where the user accesses the web site to check e-mail messages;
requesting search conditions to implement search according to conditions of the selected e-mail service;
searching a corresponding DB based on information of the search conditions input by the user to display the information; and
displaying detailed information of an e-mail message requested by the user among displayed e-mail messages.

8. The method of claim 7, wherein the e-mail services provided from the e-mail service system include an e-mail service for checking incoming/outgoing e-mail messages and an e-mail service for sending an e-mail message, and the search conditions for the selected e-mail service include at least one of an item for a required e-mail message type of the incoming/outgoing e-mail messages, an item for a desired search period from the incoming/outgoing e-mail messages, an item for respective senders, and an item for displaying read e-mail messages, e-mail messages not read, or all the incoming/outgoing e-mail messages.

9. The method of claim 8, wherein each of the incoming/outgoing e-mail messages has a message sequence number for checking its status.

10. The method of claim 9, wherein the message sequence numbers of the incoming/outgoing e-mail messages are sequentially assigned when a sender successively sends e-mail messages on even date.

11. The method of claim 9, wherein the message sequence numbers of the incoming/outgoing e-mail messages are sequentially assigned depending on the time when the e-mail messages are sent, so as to group e-mail messages sent from a sender, related e-mail messages sent from different senders, and reply e-mail messages.

12. The method of claim 7, further comprising the step of searching a DB corresponding to the web site accessed by the user to display basic information of e mail messages not read by the user or a corresponding screen.

13. The method of claim 12, wherein the basic information of the e-mail messages not read includes sender data, a brief description of the e-mail messages, and the sent date.
